(19) United States
(12) Patent Application Publication
(10) Pub. No.: US 2009/0172108 A1
(43) Pub. Date: Jul. 2, 2009

(54) SYSTEMS AND METHODS FOR A TELEPHONE-ACCESSIBLE MESSAGE COMMUNICATION SYSTEM

(75) Inventor: Gurcharan Singh, Fontana, CA (US)

Correspondence Address: PATENT GROUP 2N;JONES DAY, NORTH POINT, 901 LAKESIDE AVENUE, CLEVELAND, OH, 44114, US

(73) Assignee: SURGO, Los Angeles, CA (US)

(21) Appl. No.: 11/965,967

(22) Filed: Dec. 28, 2007

(51) Int. Cl. G06F 15/16; G10L 11/00

(52) U.S. Cl. 709/206; 704/275

(57) ABSTRACT

Systems and methods are provided for providing voice access to an electronic-mail system. A voice command is received from a call-center user to compose an electronic-mail message. The call-center user is prompted to begin vocally recording an electronic-mail message. The electronic-mail system records the vocal message recited by the call center and translates the recorded vocal message to a text message. The electronic-mail system sends an electronic-mail message to an electronic-mail address containing the translated text message.

### FIELD

The technology described in this patent document relates generally to message communication systems and more particularly to message communications systems accessible to users by telephone.

### BACKGROUND

Electronic-mail applications are well known in the art and offer a convenient means of communicating in both the business and personal realms. As the pace of society continues to quicken, the demand for increased electronic-mail access availability continues to rise. Enclosed herein are systems and methods for accessing electronic-mail and other communication functionalities through telephone and web interfaces. Functions addressed include electronic-mail, Internet, web log, and social network access. With the rise of cellular phone pervasiveness, the disclosed systems and methods offer the ability to access a user's communication resources at any time and any place the user can connect to the telephone infrastructure.

### BRIEF DESCRIPTION OF THE DRAWINGS

FIG. 1 is a block diagram depicting a message communication system.

FIG. 2 is a diagram illustrating an example operation of the message communication system processing a menu command.

FIG. 3 is a diagram illustrating an example operation of the message communication system utilizing the text to voice translation module.

FIG. 4 is a diagram illustrating an example operation of the telephone email application enabling a user to compose an email message.

FIG. 5 is a diagram illustrating an example operation of the telephone email application enabling a user to reply to an email message.

FIG. 6 is a diagram illustrating an example operation of the telephone email application enabling a user to listen to an email message.

FIG. 7 is a diagram illustrating another example operation of the message communication system enabling a user to listen to an email message.

FIG. 8 is a diagram illustrating an example operation of the telephone email application enabling a user to listen to attachments included with a received email message.

FIG. 9 is a diagram illustrating an example operation of the message communication system enabling a user to specify outside email addresses from which the message communication system should import email messages.

FIG. 10 is a diagram illustrating an example operation of the message communication system playing an email for a user through the web email application.

FIG. 11 is a diagram illustrating an example operation of the message communication system accessed through a hotel phone system.

FIG. 12 is a diagram illustrating the operation of the telephone blog application enabling a user to hear a web log through the telephone interface.

FIG. 13 is a diagram illustrating the operation of the telephone blog application enabling a user to update a web log through the telephone interface.

FIG. 14 is a diagram illustrating the operation of the web blog application enabling a user to listen to a web log through the web interface.

FIG. 15 is a diagram illustrating a system configuration enabling the integration of the message communication system's social networking module with a customer social network.

FIG. 16 is a diagram illustrating the operation of the message communication system enabling a user to search the social network for other users, to listen to other users' profiles, and to add other users to an active user's network friends list.

FIG. 17 is a diagram illustrating the operation of the message communication system enabling a user to create and edit a social network profile.

FIG. 18 is a diagram illustrating the operation of the telephone social network application enabling a user to compose a message to another network user.

FIG. 19 is a diagram illustrating the operation of the telephone social network application enabling a user to reply to a received message.

FIG. 20 is a diagram illustrating the web social network module enabling a user to access his social network messages.

FIG. 21 is a diagram illustrating the telephone web application enabling a user to view and interact with a website.

FIG. 22 is a diagram illustrating the message communication system enabling a user to access email through an embedded device.

### DETAILED DESCRIPTION

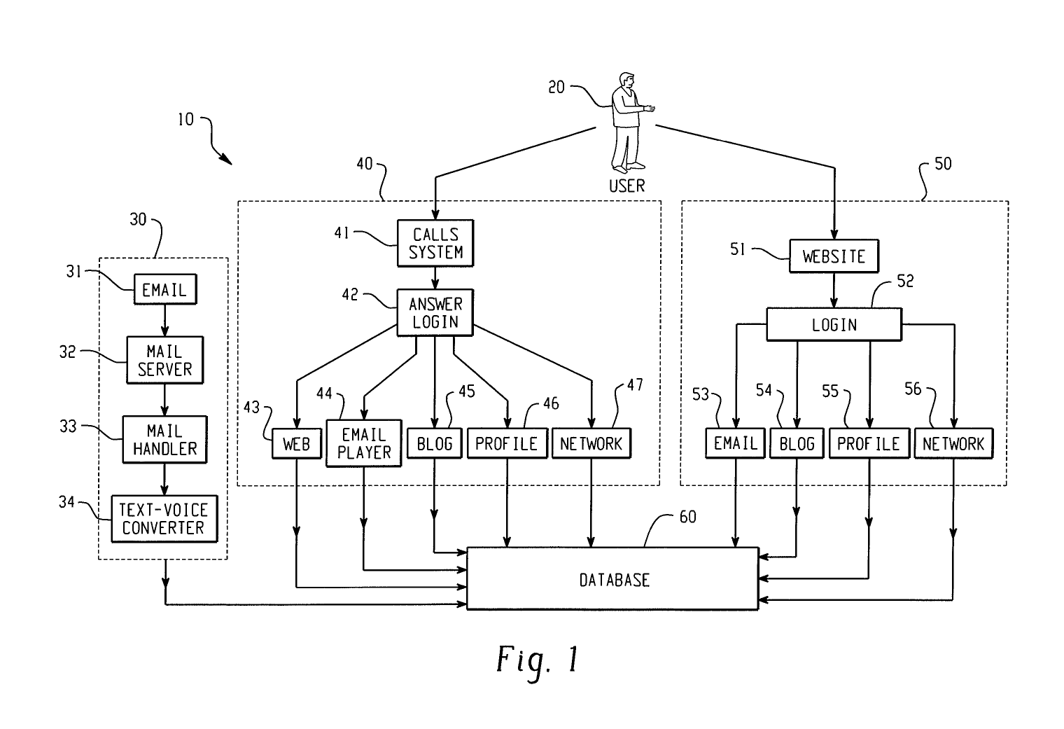

FIG. 1 is a block diagram depicting a message communication system 10. The message communication system includes an electronic-mail (“email”) system 30, a telephone interface 40, a web interface 50, and a database 60. The email system 30, telephone interface 40, and web interface 50 are all responsive to the database 60 for data storage and retrieval. In operation, the telephone interface 40 and the web interface 50 interact with the network user 20 to allow the network user 20 to access an array of applications and data.

The email system 30 includes a mail server 32 and a mail handler 33. The mail server may be a computer or collection of computers running on a network for handling the transmission and reception of emails. The mail handler 33 may include one or more software applications running on the mail server 32 or in cooperation with the mail server.

The mail server 32 interfaces with the outside network which may include the World Wide Web and Internet. Upon receipt of an email 31 for a network user 20, the mail server 32 passes the email message to the message handler 33 for processing. Alternately, upon direction from the mail handler 33, the mail server 32 facilitates the sending of an email message 31 from a network user 20 to an outside recipient. The mail handler 33 includes a text to voice/voice to text converter software application 34. Upon receipt of incoming mail from the mail server 32, the mail hander 33 directs the converter 34 to translate the text of the incoming email 31 and any readable attachments into an audio file in a format such as .wav or .mp3. The converted audio file is stored in the database 60. The text emails may be stored in a separate database from the audio files for ease of retrieval.

In addition, the converter 34 may work in the opposite direction when mail is to be sent from a network user 20. In a sending mode, the converter 34 receives an audio recording of the email to be sent, for example, in a .wav format and converted to a .mp3 format. The converter 34 translates the audio to a text representation and forwards the text representation to the mail handler 33 for further processing and for transmission over the network. In one example, the email may also include an audio recording of the message appended as an attachment.

The message communication system 10 also includes a telephone interface 40 that enables a user 20 to interface with a variety of user applications 43-47 as well as data stored in the database 60. The telephone interface 40 includes a telephone answering interface 41, a log in handler 42 and several applications 43-47. The telephone answering interface 41 may be a computer or server containing voice recognition software configured to answer a ringing telephone. The log in handler 42 may be software running on the computer which instructs the computer on protocol for logging in a user 20. The user applications 43-47 may be a collection of software applications contained on the answering computer or within the answering computer's network.

In operation, a user 20 initiates communication with the telephone interface 40 by making a telephone call 41 to the telephone interface system 40. The telephone number for reaching the telephone interface system 40 may be given to a user 20 at the time of sign-up for the message communication service or may be a publicly listed and advertised number. When the telephone interface access number is dialed, the telephone interface 40 answers and the log in handler 42 provides voice commands to enable the caller to register or to request that an existing user provide valid personal identification information in order to be permitted to log in to the system. The personal identification information may come in a variety of forms such as: a user name and password, a personal identification number, a personal knowledge security question, voice recognition, a user identifying tone sequence, as well as others. Once a user 20 has provided appropriate log in credentials to the log in system 42, the user 20 is permitted to access the suite of applications 43-47 available.

The suite of applications 43-47 may include a web-phone interface application 43 that enables a user 20 to interact with internal and external websites through the telephone interface 40. To allow communication with websites through the telephone interface 40, the web-phone interface application 43 translates a website into an audio format that is read to the user 20. The user 20 may then interact with the website by speaking voice commands. Those voice commands are translated to text and other appropriate signals and forwarded to the website.

An email application 44 allows a user 20 to access email functionality through the telephone interface 40. Utilizing the email application 40, a user may compose emails by speaking the desired message. The spoken messages are converted to a text format for transmission to the desired recipient(s). A user may also listen to received email messages that are converted from a text format into an audio format for user retrieval. The email application 44 may also have the ability to reply to messages, keep a calendar, schedule meetings and other functions commonly associated with an email application.

The telephone interface 40 may also enable a user to interact with web logs utilizing a “blog” application 45. The blog application 45 allows a user 20 to communicate with his own web log or the web log of others through the telephone. The blog application 45 enables a user to listen to existing web logs and commentary by translating the text of the web log to audio for transmission to the user 20 over the telephone. The blog application 45 may also be configured to update web logs by permitting a user to vocally record a message to be appended to the web log. This message may be attached to the web log as an audio file, or the audio recording may be translated to text. The translated text could then be submitted to the web log. In this way, the blog application 45 may be used to add web log entries to a user's own web log as well as to submit comments to the user's own or another's web log.

The telephone interface 40 may also provide a series of social networking applications that enable a user 20 to interact with other members of the message communication system 10. Utilizing the profile application 46, a user 20 may record a user profile describing himself his interests, employment, and other details he wishes to publish. This profile may be converted to text and stored in the database 60 in both audio and text form. The profile may then be accessed and read or heard by other network users.

The social network application 47 allows communication with other communication systems 10 users. The social network application 47 may provide features such as the ability to search the system for other users based on search criteria such as name, location, age, sex, interests, employment as well as many others. The social network application 47 may also allow users to send and receive messages by recording them through the telephone interface 40. These messages may then be converted to a text form with both the text and audio formats saved in the database 60 to allow either the voice or text version of messages to be received by the recipient through the telephone interface 40 or the web interface 50. The social networking application 47 may also be configured to enable a user 20 to find other users interested in having voice conversations due to the social network application's availability over the telephone interface 40.

The message communication system 10 may further include a web interface 50 that enables a user 20 to utilize the functionality of the message communication system 10 over the web. The web interface includes of a website 51, a log in handler 52, and a collection of applications 53-56. The website 51 may be hosted on a computer connected to the Internet such that a user 20 can connect to the website 51. The log in handler 52 may be a collection of code on web pages within the website 51 that controls the display of prompts and logic for logging a user 20 into the website. The web applications 53-56 may be software modules displayed on web pages within the website 51 with which users 20 can interact.

After connecting to the message communication system website 51, a user 20 is prompted to provide identification verification information to the log in handler 52. As with the telephone interface log in 42, the web log in may be presented in a variety of forms such as username/password, personal identification number, personal knowledge security question, etc. Following a successful log in, the user 20 is offered a similar suite of applications 53-56 as those offered through the phone interface 40.

The web interface 50 may include a web email application 53 that allows users 20 to compose, read, and reply to email messages. Received messages may be viewed in text form or may be heard if an audio version is saved on the database 60. An audio version of the email may be saved on the database 60 when the received email is from another message communication system 10 user who recorded the email vocally. A user 20 may draft text emails or record voice emails for sending to other message system 10 users or to destinations outside of the message system network. A user 20 may also utilize other functionality included in the email application 53 which may include calendar retention, meeting scheduling, and other functions commonly associated with email applications.

The web interface 50 may also include a blog application 54 for interaction between a user 20 and web logs. A user may add web log entries or comments to web logs using the blog portal 54. The user 20 may read and update web logs through the traditional text methods normally associated with web log interaction. The user 20 may also utilize functionality similar to that utilized with the telephone blog application 45 where the user 20 records web log updates and comments vocally, and the recordings are translated to text for posting. The web log posting could include the text and/or the audio recording depending on the user's preference.

The web interface 50 may further include a web interface 56 to the social network. Through the profile application 55, a user may create and edit a social network profile in text and/or audio format for storage on the database 60. Audio recordings may be translated to text and vice versa for transmission to other network users according to their interface of choice and user preferences. The web interface 50 social network application 56 may also contain similar search and messaging functionality as offered with the telephone interface 40 such that a user 20 may search for other users based on any number of search criteria and view or listen to the other users' profiles. Once another user is found, voice and text messages may be sent as well as invitations to voice and/or video chat sessions.

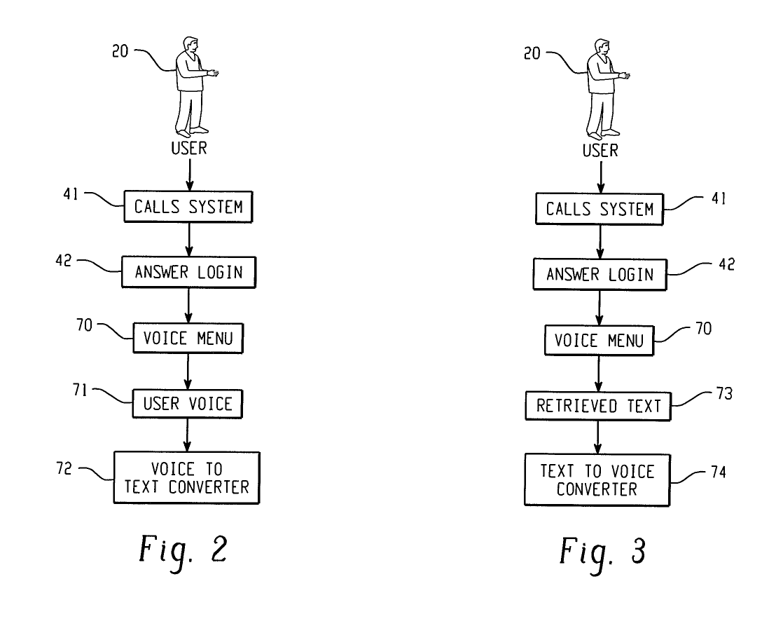

FIG. 2 is a diagram illustrating an example operation of the message communication system 10 processing a menu command. In this example, the user 20 calls the message communication system 41 and logs in 42 explained above. Following log in 42, the user 20 is presented with a main menu 70 which the message communication system 10 communicates to the user 20 by playing an audio file through the telephone in a format such as .wav. Following presentation of the voice main menu 70, the system is configured to receive a voice command 71. Because the computer is ill-equipped to respond to analog voice commands, the spoken command 71 is translated to a digital, text format by a voice to text converter 72. The digital command is then forwarded to the message communication system 10 for processing the menu selection.

Because the telephone interface module 40 is not well suited to transmitting text to a user 20 without some type of translation, a text to voice converter is also useful to the telephone interface module 40. The message communication system 10 utilizes text to voice translation in a variety of telephone interface module 40 applications. Text to voice translations are used in reading emails, blogs, and text social network profiles to users 20 as well as other scenarios. These text sources may be converted to voice representations upon request, upon receipt, periodically, or at other times according to user and administrator preference.

FIG. 3 is a diagram illustrating an example operation of the message communication system 10 utilizing the text to voice translation module. In this example, the user 20 calls the message communication system 41 and logs in 42 as described above. Following log in 42, the user 20 is presented with a main menu 70 which the message communication system 10 reads to the user. By vocally entering a command to hear new emails, the user causes the message communication system to retrieve the text 73 of a received text email and translate the text to voice using the text to voice converter 74. The resulting audio file is then played through the telephone interface module 40 for the user 20 to hear.

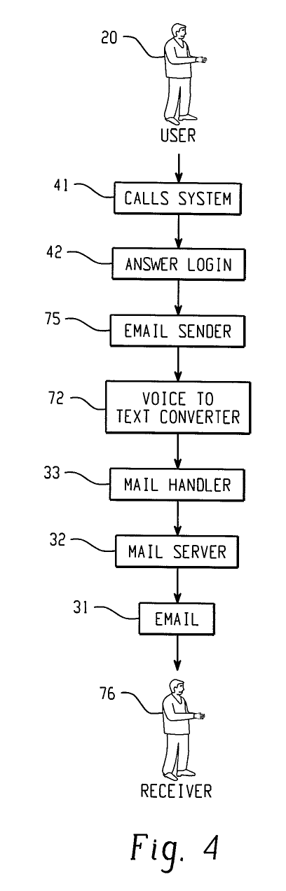

Referring again to FIG. 1, the email-player application 44 within the telephone interface module 40 may be configured to send and receive emails as well as reply to received emails and other functionality commonly associated with email applications such as Microsoft Outlook™ and Lotus Notes™. FIG. 4 is a diagram illustrating an example operation of the telephone email application 44 enabling a user 20 to compose an email message. In this example, a user 20 calls the system 41 utilizing the telephone interface module 40 and logs in to the system 42 as described above. The message communication system 10 presents the user with a series of menus for navigation. In this example, the user 20 has selected the option to compose an email. The telephone email application 44 prompts the user 20 to recite destination information which is translated to an email address. The user 20 is also prompted to dictate the message he wishes to send. The email sender 75 records the dictated message. Following dictation of the message by the user 20, the recorded message is forwarded to the voice to text module 72 for conversion to a text format. The converted text email is then forwarded to the mail handler 33 for processing. A copy of the recorded message may or may not be attached to the outgoing email. The mail handler 33 appends appropriate email tags and completes the necessary processing to create a valid email containing the message and destination information requested by the user 20. The completed email is then forwarded to the mail server 32 which transmits the email 31 to the desired recipients 76.

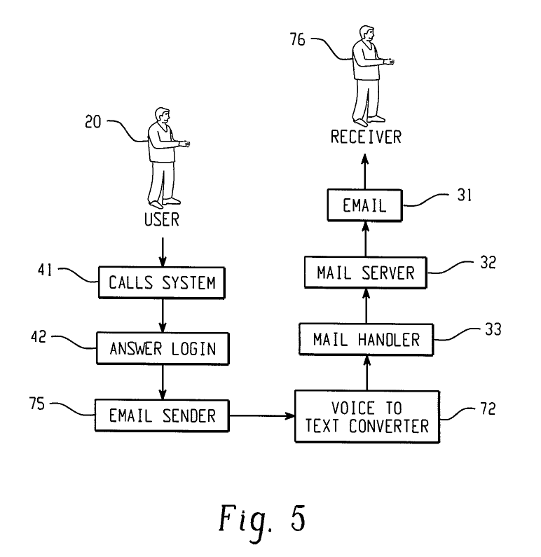

FIG. 5 is a diagram illustrating an example operation of the telephone email application 44 enabling a user 20 to reply to an email message. In this example, a user 20 calls the message communication system 41 and logs into the system 42. Following selection of the email player application 44, the user 20 is able to listen to received email messages. After playing the message, the user 20 is presented with a menu of options which includes the option of replying to a message. In this example, the user 20 has chosen to reply to a message to which he has listened. While a reply message is assumed to be addressed to the sender of the received message, an option may be provided to add or edit the list of recipients of the new message. In addition to confirming the destination information, the email sender 75 also prompts the user 20 to dictate his reply message, which is then recorded. Following dictation of the reply message, the recorded message is forwarded to the voice to text module 72 for conversion to a text format. The converted text email is then forwarded to the mail handler 33 for processing. In addition, a copy of the recorded message may optionally be attached to the outgoing email. The mail handler 33 appends appropriate email tags and completes the necessary processing to create a valid email containing the message and destination information requested by the user 20. The completed email is then forwarded to the mail server 32 which transmits the email 31 to the desired recipients 76.

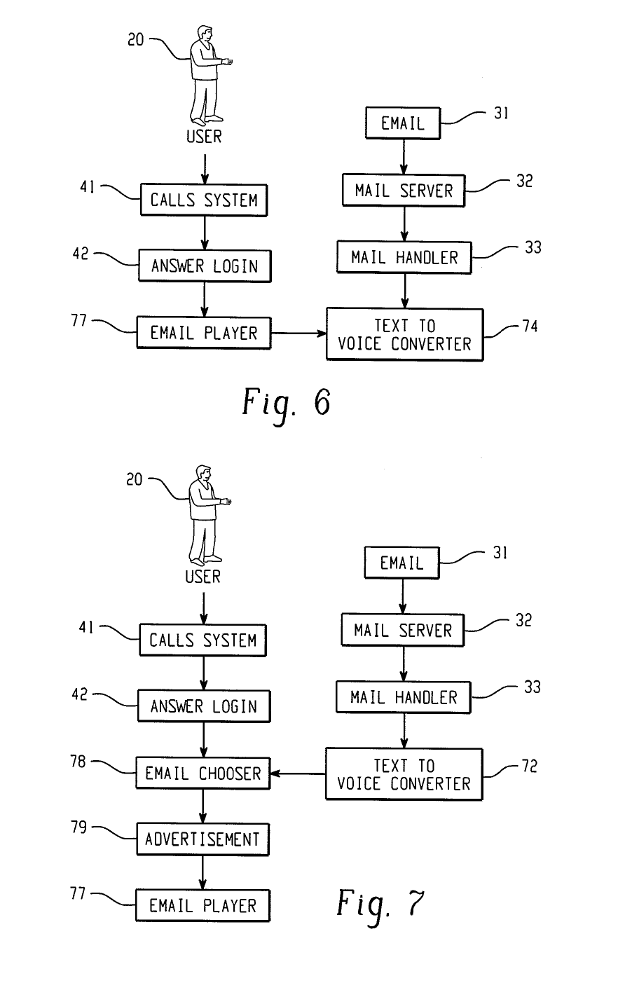

With reference again to FIG. 1, the email player 44 may also be capable of playing audio translations of received emails through the telephone interface module 40. FIG. 6 is a diagram illustrating an example operation of the telephone email application 44 enabling a user 20 to listen to an email message. In this example, a user calls the message communication system 41 and logs in 42. In this example, the user 20 navigated the voice-enabled menus to select an option for listening to an email message. In a parallel action path, an email 31 to a message communication system user 20 is received by the mail server 32 and forwarded to the mail handler 33 for processing. The mail handler determines the proper network user 20 to which to route the email message 31 and directs the text to voice converter 74 to translate the message into an audio representation which is stored in a format such as .wav or .mp3 in the database 60. Upon receipt of a command to play a received email message, the email player 77 retrieves the audio representation of the message from the database 60 and plays the audio representation for the requesting user 20.

FIG. 7 is a diagram illustrating an example operation of the message communication system 10 enabling a user 20 to listen to an email message. In this example, the message communication system 10 is being run under a hybrid subscription/advertising schema. Under this schema, a user who chooses to pay a monthly service fee is able to utilize the system applications without being required to listen to advertisements. However, a user who chooses to utilize the free version of the service is forced to listen to an advertisement at certain points during his time on the network in order to generate revenue for the service provider. In the example of FIG. 7, a user 20 has chosen to listen to an email in a similar fashion as described in FIG. 6. Following calling the system 41 and logging in 42, the user navigates a series of menus and chooses an email to which to listen 78. As in the previous example, an incoming email 31 to the user 20 has previously been received by the mail server 32, processed and routed by the mail handler 33, and converted to an audio representation 34 by the text to voice converter 74. However, in this example, the user 20 of the free version of the service must listen to an advertisement 79 before he is permitted to listen to the email he has received 77. Following playing of the advertisement 79, the user may listen to his message.

It should be understood that in other examples, the message communication system 10 may function under a variety of payment modes. The system 10 could be run as a free service whereby users could log in and utilize the system applications without the payment of any fees. The system 10 could also be utilized as a subscription based system whereby users would be charged a flat monthly rate, per hour of usage, per volume of data transfer or some other measure or combination of measures. The system could also be maintained utilizing advertising revenues. In an advertisement scenario, such as shown in FIG. 7, advertisers would pay the system service provider to have messages displayed or played for system users 20. The advertiser could be charged per the number of times his advertisement is played, or the advertiser could also be charged based on the length of time his advertisement is in the rotation of advertisements to be played.

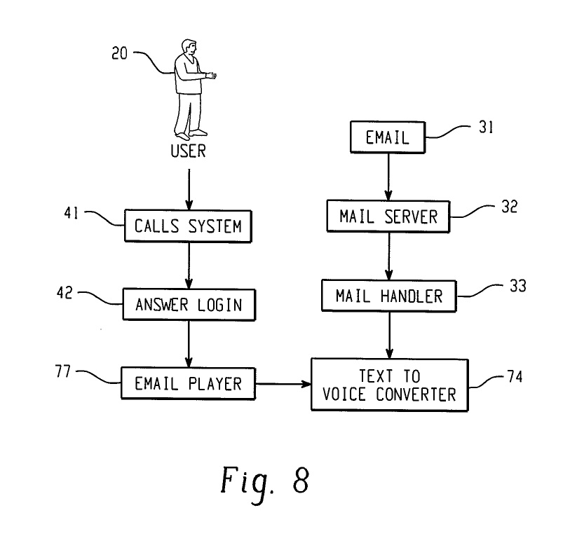

FIG. 8 is a diagram illustrating an example operation of the telephone email application 44 enabling a user to listen to attachments included with a received email message. In this example, a user 20 calls the system 41 and logs in 42. Following navigation of voice menus, the user 20 has selected to listen to an email through the email player 77. As described above, an incoming email 31 is received by the mail server 32 and forwarded to the mail handler 33 for processing. The mail handler 33 then directs the text to voice converter 74 to translate the text of the email into an audio representation that may be played to the user through the telephone interface module 40. Upon receipt of an email containing an attachment, the text to voice converter 74 may also be instructed to translate the contents of the email attachment into an audio format for storage in the database 60. Upon completion of an email playback to the user 77, the user is offered a series of options including listening to email attachments. If the user should choose to listen to an email attachment, email player 77 retrieves the audio representation of the attachment and plays the audio representation for the user 20. Email attachments of a variety of types may be translated from their text format to voice including .txt, .doc, xls, .wp, as well as many others. Additional file type translation modules may be added to the text to voice converter 74 for handling of additional file types which may not be included in the base version of the converter 74.

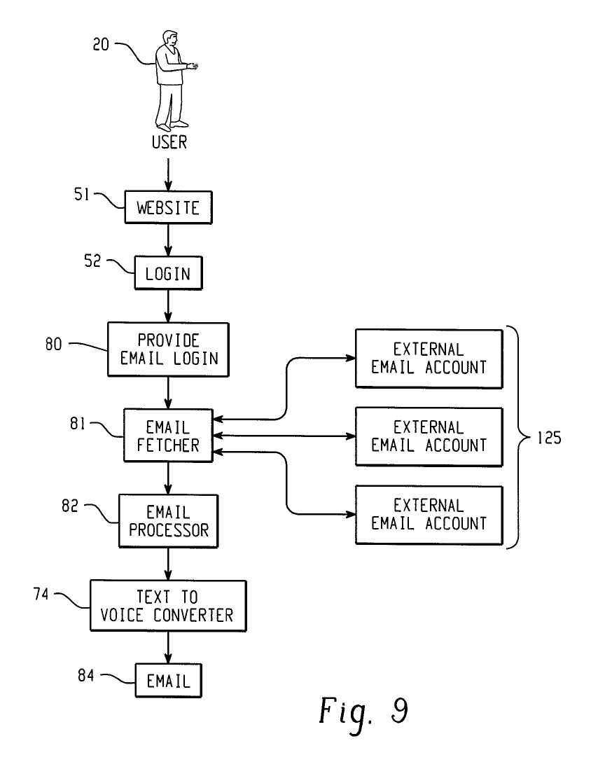

With reference again to FIG. 1, the message communication system 10 may provide users with their own system email address to which the user may have messages sent or forwarded. In addition, a user 20 may enter routing and log in information for other email addresses (such as outside post office protocol (POP) accounts) from which the user 20 wishes to have messages imported. FIG. 9 is a diagram illustrating an example operation of the message communication system 10 enabling a user to specify outside email addresses from which the message communication system 10 should import email messages. In this example, the user 20 logs onto 52 the web interface 50 through the main website 51. In this example, following navigation of menus, the user 20 has identified that he is interested in setting up the importing of emails from an outside account. The user 20 is prompted to enter necessary routing and log in information for the target email account from which he desires email to be imported 80. Following successful entering of this information, the email fetcher 81 will periodically poll the target email accounts 125 to determine if any new messages are present. This polling may also be initiated at the user's request. If new email messages are present in the target account, then the email fetcher 81 requests a copy of the messages and forwards the copies to the email processor 82. Following importing by the email fetcher 81, the retrieved email messages residing in the outside email account may or may not be deleted according to user preference. The email processor 82 then formats and processes the retrieved email, and the text to voice converter 74 may translate the text message to an audio representation for storage on the server 60. Following completion of this process, the email message 84 appears in the user's 20 inbox for retrieval.

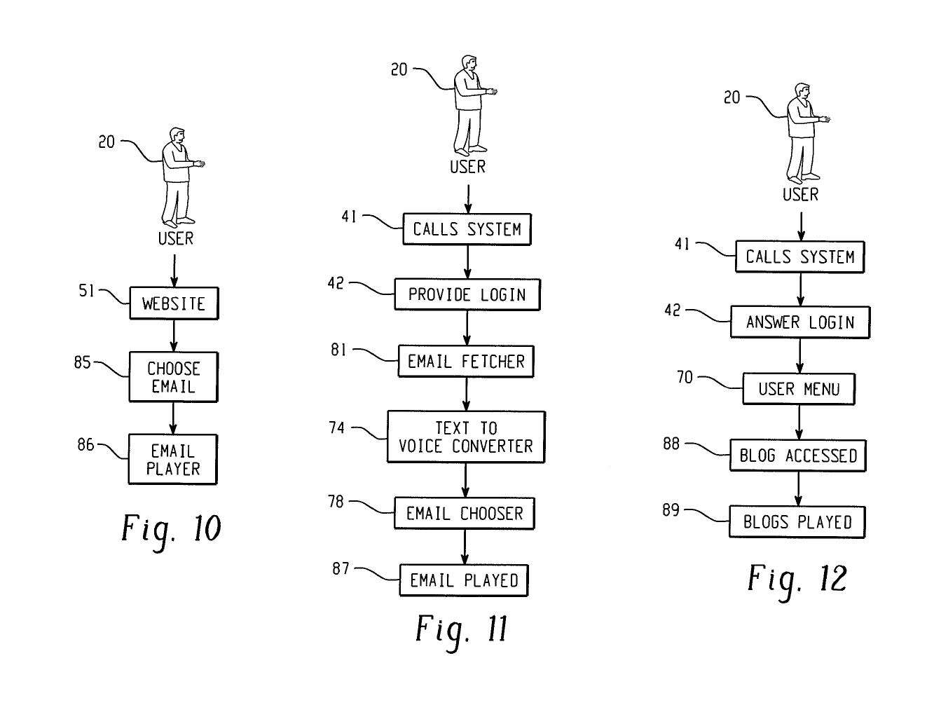

With reference to FIG. 1, the email application 53 of the web interface 50 may offer a text and image email application similar to those offered by other online email services such as Yahoo Mail™, Hotmail™, Gmail™, etc. In addition to offering basic email services, the message communication system 10 may also offer the ability to listen to emails through the web interface 50. FIG. 10 is a diagram illustrating an example operation of the message communication system 10 playing an email for a user 20 through the web email application 53. In this example, the user 20 has accessed and logged into the web interface 50 through the website 51. The user has navigated the web menus to the email application 53 and chosen to listen to an email. An audio version of the email may have been created by the text to voice converter 74 upon receipt of the email by the mail server 32. If an audio version exists, then the audio version is accessed from the database 60 and played for the user 20 through the user's computer 86. If an audio version is not yet created, then the text to voice converter 74 creates an audio representation of the text email and forwards the audio representation to the user's 20 computer for playback.

With reference again to FIG. 1, the functionality of the message communication system 10 can be implemented in a variety of creative scenarios. One such scenario is the implementation of the telephone interface module 40 through a hotel phone system. A user 20 may keep a set of email addresses on file with the hotel or may indicate email addresses and account log in information at check in time. For example, the user 20 may be given log in information to allow the user 20 to access the telephone interface module 40 through the hotel phone system. FIG. 11 is a diagram illustrating an example operation of the message communication system 10 accessed through a hotel phone system. In this example, a user 20 utilizes the hotel phone system to call the system 41. The user is prompted to enter the log in information given by the hotel, and upon successful entry of this identification information 42, the user 20 is permitted access to the system. In this example, the user has chosen to access the email player application 44 through the telephone interface 40. Upon entry into the email application 44, the email fetcher 81 polls the email accounts identified by the guest and retrieves any new messages. These retrieved messages are converted to audio by the text to voice converter 74 and made available for access. A list of available emails may be presented to the user by reading the sender's name and message subject. Utilizing the menus of the email chooser 78, the user 20 identifies which message he would like to hear, and the selected email is played 87 for the user 20 through the telephone interface 40.

With reference to FIG. 1, the message communication system 10 offers a number of additional communication applications outside of email. The blog applications 45 and 54 offer functionality for a user 20 to interact with Internet web logs. Through these applications, a user 20 may hear, read, update, and comment on web logs as desired. FIG. 12 is a diagram illustrating the operation of the telephone blog application 45 enabling a user 20 to hear a web log through the telephone interface 40. In this example, the user 20 calls the message system 41 and logs in 42. Through navigation of the user menus 70, the user 20 has indicated a desire to listen to a web log. The list of web logs a user wishes to regularly access may be stored in the database 60. Items on this list may be added, edited, and deleted as desired by the user 20. After a user has identified a web log that he wishes to hear, the blog application 45 accesses the desired web log 88 and instructs the text to voice converter 74 to create an audio representation of the web log. The web log is then played 89 for the user 20 through the telephone.

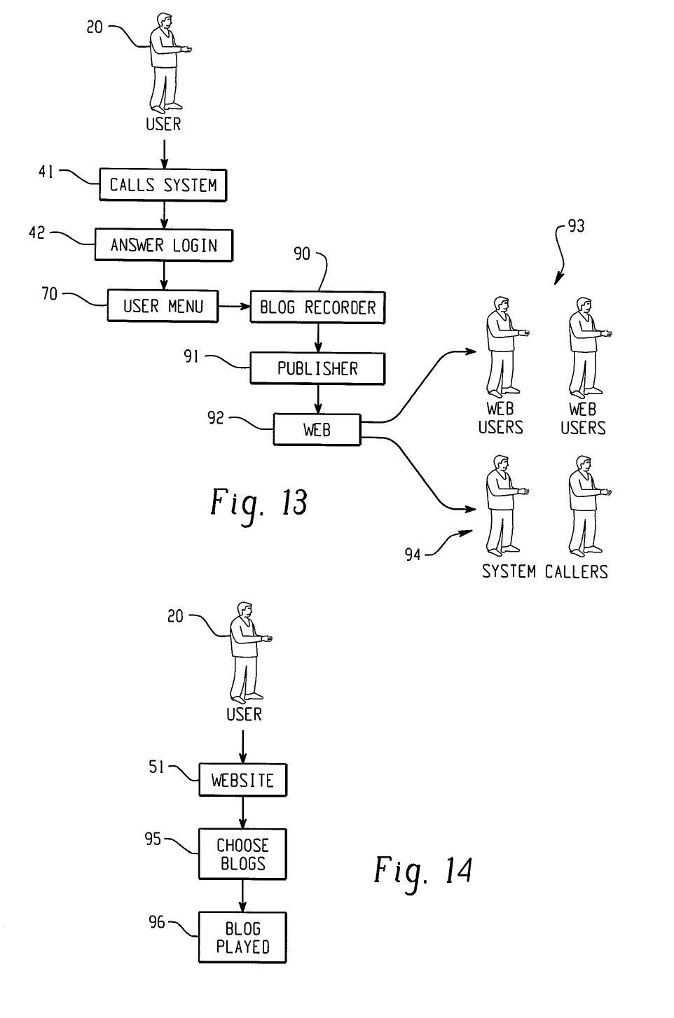

Referring again to FIG. 1, In addition to enabling a user to listen to a web log through the telephone interface 40, the blog application 45 allows a user 20 to update a web log as well. An update to a web log may be a new entry into the user's own web log or the update may be the addition of a comment to an existing web log entry. FIG. 13 is a diagram illustrating the operation of the telephone blog application 45 enabling a user 20 to update a web log through the telephone interface 40. In this example, the user 20 calls the messaging system 41 and logs in 42. Through the use of user menus 70, the user 20 navigates to the blog application 45 and indicates a desire to update a web log. At a prompt from the blog application 45, the user 20 records the desired update message 90. The recorded message is translated to text by the voice to text converter 72 and published to the web 92 by the web publisher 91. The web log update may include the recorded audio message or the translated text or a combination of both. Once published on the web, the web log update is available by all web users 93 as well as users 94 of the message communication system 10.

With reference again to FIG. 1, the web interface blog application 54 offers audio web log transmission as well as the traditional text web log viewing. Similar to the web email application 53 which allows a user to listen to an email through the web interface 50 as well as reading the email through text, the web blog application 54 enables the user to listen to web logs he selects. FIG. 14 is a diagram illustrating the operation of the web blog application 54 enabling a user 20 to listen to a web log through the web interface 50. In this example, a user 20 accesses the interface website 51 and logs in. Through the web interface 50, the user may define and edit a list of favorite web logs he wishes to visit as well as specifying a particular web log to access. After the user has chosen a web log to hear 95, the web log is accessed and translated through the text to voice converter 74. The audio representation of the web log text is then read 96 to the user 20 through the telephone interface.

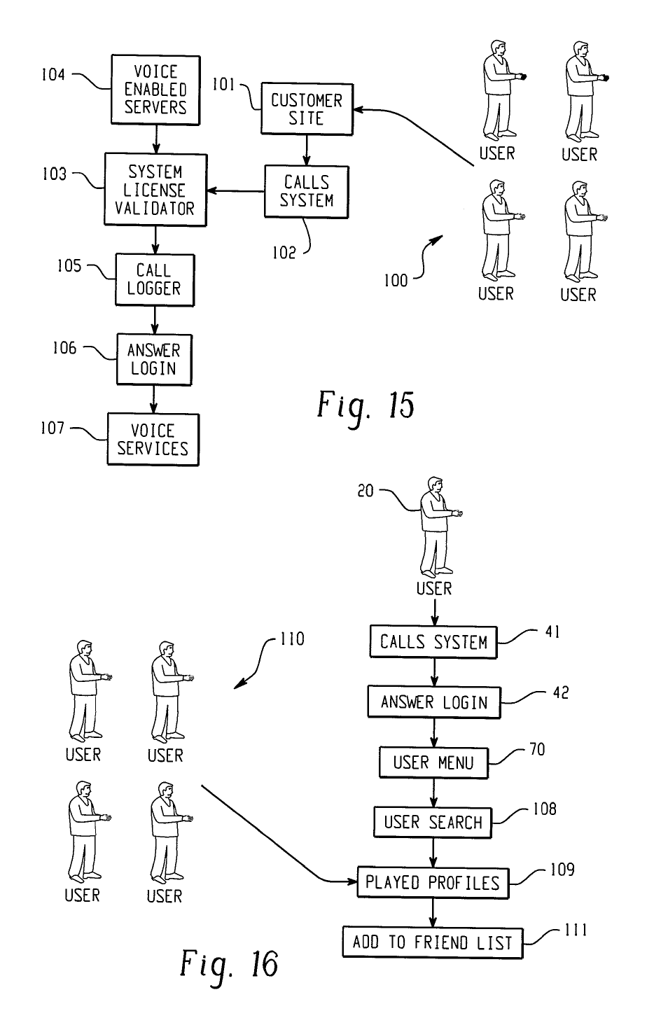

Referring to FIG. 1, the message communication system 10 offers social network functionality for creation of an online community as well as integration into existing online communities through the use of social network applications 46, 47, 55, and 56. FIG. 15 is a diagram illustrating a system configuration enabling the integration of the message communication system's 10 social networking module with a customer social network such a MySpace™, Facebook™, Bebo™, etc. In this example, a user 100 of a customer social networking site 101 calls the message communication system 10. A system license validator module verifies that the social network the user 100 wishes to access is a valid network which has taken a license on the added features offered by the message communication system 10. If the social network is deemed valid, a user 100 is granted access to the message communication system functionality. In this example, the user 100 is logging on to the telephone interface 40. Thus, upon validation, the voice enabled server 104 logs the user call 105 and requests log in identification 106. Upon production of valid identification information, the user is granted access to the voice services 107 through the voice menus. The user may then access the social network applications 45 and 46 for the internal social network contained within the message communication system 10 as well as the external licensed customer social network.

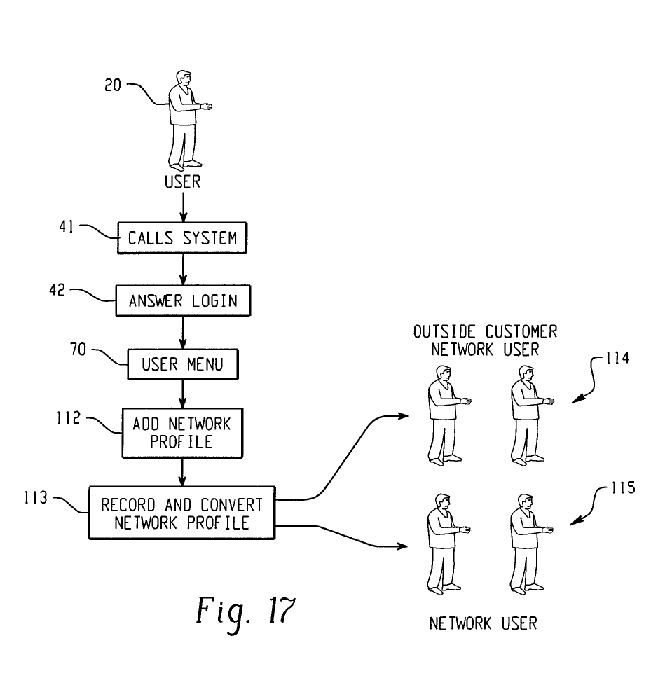

With reference again to FIG. 1, a user of the message communication system's 10 social network and/or an external customer social network may be provided with an array of functionality through the profile 46 and 55 and network 47 and 56 applications. One functionality is the ability to search for and add other users to a friends list. FIG. 16 is a diagram illustrating the operation of the message communication system 10 enabling a user 20 to search the social network for other users 110, to listen to other users' 110 profiles, and to add other users 110 to an active user's 20 network friends list. In this example, a user 20 calls the system 41 and logs in 42. Once logged in, the user navigates a series of menus 70 to enter the social network applications 46 and 47. In this case, the user has indicated a desire to search 108 the user profiles contained within the social network. To execute this search, the user is prompted to recite the search criteria he would like to execute. Because the search mechanism may not be well suited for searching based on audio representations of search criteria, the user search mechanism 108 may request that the voice to text converter 72 translate the search string into text. The user search mechanism 108 then runs the profile search of network users 110.

Following completion of the profile search 108, the user 20 is presented with a listing of member profiles which match the user search criteria. This search match listing may be limited in size due to time limitations in the use of the telephone medium for reciting long lists. However, the user may be offered the option of receiving more search results should he desire. After the network application 47 recites the list of matching profiles, the user 20 may select one or more profiles to be played. The profile player 109 plays any audio components of the selected user profile stored on the database 60. In addition, any text portions of profile stored are translated to audio by the text to voice converter 74 and played back for the user 20. In this manner, the user 20 may hear details about a user such that he may decide with which users he wishes to pursue further communications. To remember these users of interest, the user 20 may add the selected network user 110 to his friends list 111. Adding a user 110 to a friends list stores that user's 110 name and contact information such that their profile can be readily viewed in the future and messages to that user 110 can be easily routed.

With reference to FIG. 1, while searching and messaging functions are available to the user 20 through the network applications 47 and 56, the profile modules 46 and 55 offer the user 20 an opportunity to build and edit a profile that other users may search and view. FIG. 17 is a diagram illustrating the operation of the message communication system 10 enabling a user 20 to create and edit a social network profile. In this example, a user 20 calls the system 41 and logs into the system 42. The user navigates a system of user menus 70 to reach the social network profile application 46 through the telephone interface 40. The user 20 has indicated his desire to add a network profile. The add network profile module 112 prompts the user to begin speaking and records the user's network profile. The voice to text converter 72 converts 113 the voice recording to text and stores both the audio recording and text in the database 60. Upon saving the added profile to the database 60, the profile is now available for searching and viewing by users of the message communication system social network 115 as well as outside customer network users 114.

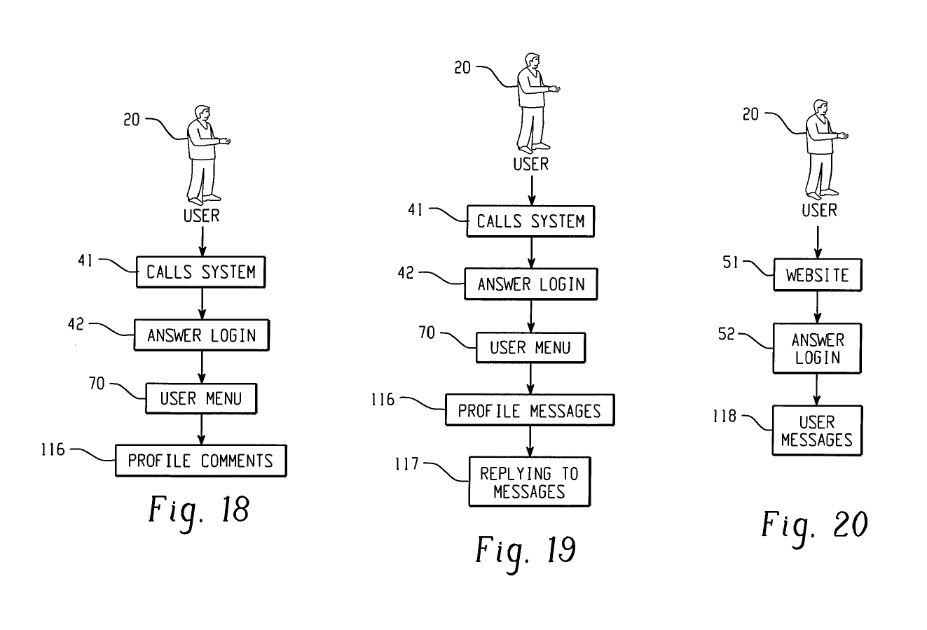

Referring to FIG. 1, once a user 20 has found another network user of interest, he may wish to leave that user a message. This can be done through text messages using the web network application 56 and can also be accomplished through the telephone interface 40 using the telephone network application 47. FIG. 18 is a diagram illustrating the operation of the telephone social network application 47 enabling a user 20 to compose a message to another network user. In this example, a user 20 has called the telephone system 41 and logged into the system 42. By navigating the user menus 70 the user 20 has indicated a desire to leave a profile comment 116. Upon entering the profile comment module 116, the user 20 is prompted to recite the name of the network user he wishes to message. The target network user may be contained on the user's 20 friends list or may be identified by the user 20 by name, email address, or other identifying information. Once the target network user has been identified, the profile comments module 116 prompts the user 20 to begin reciting his message. The profile comments module 116 records the message and instructs the voice to text converter 72 to create a text representation of the recorded message. Both the text and recorded message may be saved on the database 60 for future access. Saving both forms of the message allows the target network user to retrieve the message according to his preferences.

With reference again to FIG. 1, upon receiving a message through the social network application, a user may then wish to reply to the sender and continue the conversation. FIG. 19 is a diagram illustrating the operation of the telephone social network application 47 enabling a user 20 to reply to a received message. In this example, the user 20 has called the system 41 through the telephone interface 40 and logged in successfully 42. Following log in 42, the user has navigated the user menus 70 to reach the social network application 47. Upon entering the social network application 47, the user 20 may be notified that he has received a message from another network user. Utilizing the profile messages module 116, the user 20 may listen to his received message. If the message was recorded in audio form, the actual recorded message from the sending user may be played back allowing the user 20 to hear the sending user's actual voice. If the message has only been retained in text form, the voice to text converter 74 may be used to translate the text message into an audio form which may be played through the telephone interface 40. After listening to the message, the user 20 is prompted with a series of options, one of which is replying to the received message 117. If the user 20 chooses to reply to the message 117, the profile message module 116 prompts the user to dictate his desired message. The profile message module 116 records the message and may instruct the voice to text converter 72 to translate the message to text. The audio recording and text translation may then both be stored in the database 60 for later retrieval.

While the previous examples have highlighted activities utilizing the social network through the telephone interface 40, the same functionality is available using the web social network application 56. Through the web social network application 56, users may create profiles, search for other network users, and send and receive messages through the same social network. For example, messages received may be accessed through either the telephone 40 or web 50 interfaces. FIG. 20 is a diagram illustrating the web social network module 56 enabling a user 20 to access his social network messages. In this example, a user 20 connects to the service website 51 and logs into the system 52. After a successful log in 52, the user navigates the web menus to access the web social network application 56. Upon entering the web social network application 56, the user 20 may be notified that he has received new messages. By clicking a link with a mouse or by some other selection method, the user 20 is able to select the received message. The received message may be shown to the user 20 in text form or played through the user's 20 computer speakers in audio form. The audio form may contain the actual voice of the sender if such a representation has been saved in the database 60 or may be a translated version created by the text to voice converter module 74. Other functionality described with respect to the telephone interface 40 may also be implemented through the web interface 50.

With reference to FIG. 1, the message communication system 10 may also offer a telephone web application 43 for accessing web pages through the telephone interface 40. The telephone web application 43 enables a user 20 to select a web page for interaction. The text to voice converter module 74 translates the page into an audio representation conducive for transmission through the telephone interface 40. The user 20 is then able to interact with the page by giving voice or telephone keypad commands. This may be accomplished, for example, by reading the user 20 a list of links on the page following recitation of the audio page translation. The user 20 is then permitted to select one of these links for traversal. This may be accomplished by taking advantage of the typical format for coding an HTML link. A typical HTML link is coded as follows:

<a href=“http://www.yahoo.com”>Visit Yahoo.com</a>

When a web page is viewed through a traditional web browser, the text between the tags (“Visit Yahoo.com”) is displayed on the web page and identified as a link by a change in color, highlighting, underlining, or some other identification. Clicking the link text directs the web browser to fetch the page indicated by the link destination (“href”) portion of the link code. This may be implemented in the telephone web application 43 by translating the text between the link tags to audio using the text to voice converter 74 and reading this text for each link to the user 20. The user 20 then selects his link of choice and the telephone web application 43 fetches the selected website. Similar functionality may be implemented for filling out web forms utilizing voice to text translation and other web browsing functionality.

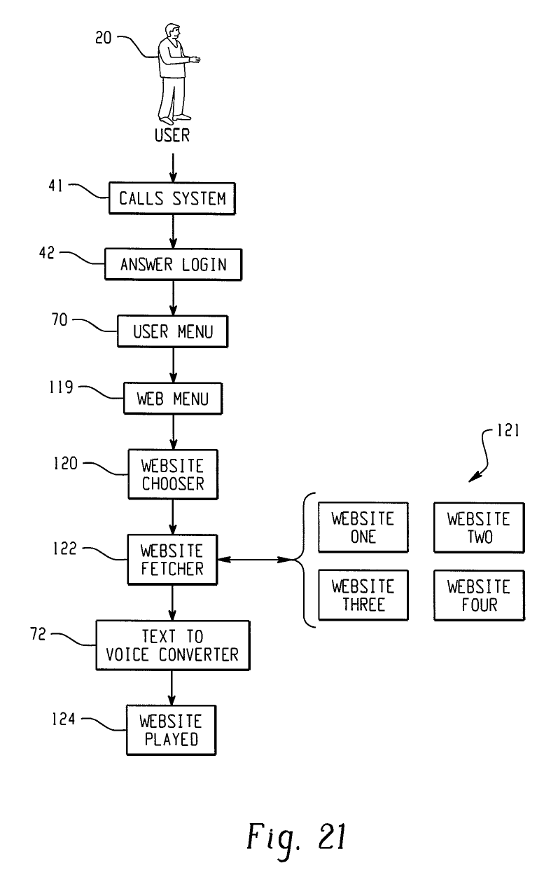

FIG. 21 is a diagram illustrating the telephone web application 43 enabling a user 20 to view and interact with a website. In this example, a user 20 calls the system 41 and logs into the system 42. Navigating the telephone menus 70, the user 20 selects the telephone web application 43. Upon entering the telephone web application 43, the user 20 is presented with the telephone web application menu 119 which prompts the user 20 to direct the application as to where he would like to begin browsing. The user 20 may dictate pages to be accessed through a list of favorite websites which he may edit or by reciting the web address of a website. The user's choice of website is deciphered by the web chooser module 120 which translates the user's 20 voice commands to text using the voice to text converter 74 and directs the website fetcher module 122 to access the desired page. The website fetcher module 122 accesses the Internet 121 and requests the desired website. Upon receipt of the desired website, the website data is transferred to the text to voice converter 72 and translated into an audio file. The audio file is then played 124 for the user 20. As described above, the user 20 may then interact with the page and access other pages through the use of links, their favorites list, or by reciting a new website address to access.

The systems and methods described above outline the functionality associated with the message communication system 10. The message communication system may be implemented through telephones and computers. However, the system may also be incorporated into other embodiments which offer further improvements in convenience and safety. One such embodiment is the integration of the message communication system into a motor vehicle. Integrated as such, the message communication system offers a way for a user to access the web, email, and social networks in a hands free medium allowing a user to maintain a safe driving environment. An embedded system could be integrated into the console, radio, steering wheel or other convenient portions of a vehicle. A one touch button could direct the embedded system to connect to the message communication system 10. Once connected, the user could access the full array of message communication system 10 applications.

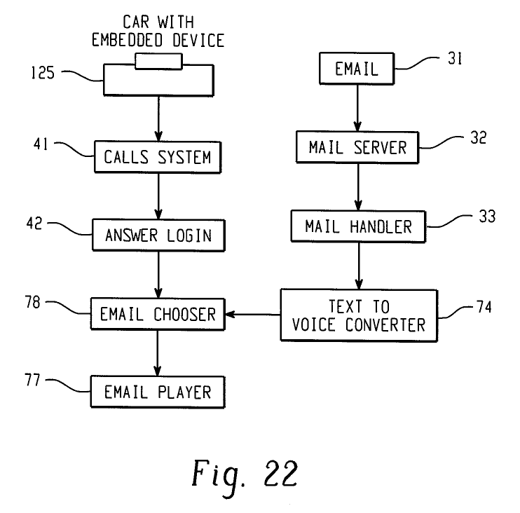

FIG. 22 is a diagram illustrating the message communication system 10 enabling a user 20 to access email through an embedded device 125. In this example, a user 20 activates an embedded network messaging system device 125 and instructs the embedded device to connect to the system 41. In response, the embedded device 125 dials the telephone interface 40 and connects. The user provides identifying log in information 42 and is permitted to proceed to access the applications. The user's 20 experience is then similar to that of one utilizing the telephone interface 40 through a speaker phone. In this example, the user 20 has navigated the user menus and chosen to access his email through the email application 44. Emails 31 which have been received by the mail server 32 have been forwarded to the mail handler 33 for processing. The mail handler 33 has directed the text to voice converter 74 to create and store an audio representation of the received email 31 in the database 60. Upon instruction from the user 20, the email chooser 78 accesses the email identified by the user 20 and plays 77 the audio representation through the telephone interface. The user may then reply to the message, compose a new message, or move to another telephone application as could be done using a traditional telephone as described earlier.

This written description uses examples to disclose the invention, including the best mode, and also to enable a person skilled in the art to make and use the invention. The patentable scope of the invention may include other examples that occur to those skilled in the art.

It is further noted that the systems and methods described herein may be implemented on various types of computer architectures, such as for example on a single general purpose computer or workstation, or on a networked system, or in a client-server configuration, or in an application service provider configuration.

It is further noted that the systems and methods may include data signals conveyed via networks (e.g., local area network, wide area network, internet, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform methods described herein. Other implementations may also be used, however, such as firmware or even appropriately designed hardware configured to carry out the methods and systems described herein.

The systems' and methods' data (e.g., associations, mappings, etc.) may be stored and implemented in one or more different types of computer-implemented ways, such as different types of storage devices and programming constructs (e.g., data stores, RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It is claimed:

1. A method for providing voice access to an electronic-mail system comprising:
receiving a voice command from a call-center user to compose an electronic-mail message;
prompting the call-center user to begin vocally recording an electronic-mail message;
recording the vocal message recited by the call-center user;
translating the recorded vocal message to a text message; and
sending an electronic-mail message to an electronic-mail address containing the translated text message.

2. The method of claim 1 further comprising:
playing received electronic-mail messages to the call-center user; and
translating received text electronic-mail messages to audio representations of the text electronic-mail messages prior to playing received electronic-mail messages to the user.

3. The method of claim 1 further comprising:
prompting the call-center user to vocally recite electronic-mail destination information;
recording the recited electronic-mail destination information; and
translating the recorded electronic-mail destination information into a text electronic-mail address,
wherein the electronic-mail message is sent to the translated text electronic-mail address.

4. The method of claim 3, wherein the electronic-mail destination information is an address-book record identifier associated with an electronic-mail address or an electronic-mail address.

5. The method of claim 1 further comprising attaching a copy of the recorded vocal message to the electronic-mail message.

6. The method of claim 1, wherein the received voice command to compose an electronic-mail message is in reply to a previously received electronic-mail message.

7. The method of claim 1 further comprising the following steps prior to receiving a command to compose and electronic-mail message:
receiving a voice communication from the call-center user; and
verifying identity of the call-center user.

8. The method of claim 7 further comprising prompting the call-center user with an audio menu navigated by voice commands from the call-center user detailing menu options available to the user, said menu options including navigation to sub-audio-menus where further menu options are described to the user and action options, said action options including reading electronic-mail messages and composing electronic-mail messages.

9. A method of updating a web log using an electronic call-center comprising:
receiving a voice command from a call-center user to update a web log;
prompting the call-center user to begin vocally recording a web log update message;
recording the vocal web log update message recited by the call-center user;
translating the recorded vocal web log update message to a text message; and
updating the web log by appending the text message to the web log.

10. The method of claim 9 wherein the text message updating the web log is a comment to a web log entry.

11. The method of claim 9 wherein the text message updating the web log is a web log entry.

12. A social networking system configured to facilitate networking among a plurality of network users utilizing a voice dial-in call center comprising:
a data storage medium;
a profile entry and edit application configured to create and edit a network profile to be stored on the data storage medium;
a search application configured to search records stored on the data storage medium for other network users based on a set of search criteria; and
a voice-text messaging interface application configured to record a vocal message to another network user and translating the recorded vocal message to a text message to be stored on the data storage medium,
the voice-text messaging interface being further configured to access a received message. translate the received message to an audio representation of the received message, and play the translated received message.

13. The social networking system of claim 12 further comprising a plurality of voice navigated menus for accessing the profile entry and edit application, the search application, the message sending application, and the message receiving application.

14. The social networking system of claim 12 further comprising an online application configured to enable a network user to read and write text messages stored on the storage medium over the Internet without utilizing a voice phone.

15. The social networking system of claim 12, wherein the set of search criteria include one or more characteristics selected from the group consisting of network-identifier, name, location, group membership, age, sex, and interests.

16. A method of sending electronic-mail from within a motor vehicle utilizing an embedded access console comprising:
receiving a call from a call-center user, initiated by a button-press or voice command, through the embedded access console;
receiving a voice command from the call-center user to compose an electronic-mail message through the embedded access console;
prompting the call-center user to begin vocally recording an electronic-mail message through the embedded access console;
recording the vocal message recited by the call-center user through the embedded access console;
translating the recorded vocal message to a text message; and
sending an electronic-mail message to an electronic-mail address containing the translated text message.

17. A method of facilitating interaction with web content by voice over the phone comprising:
receiving a request from a call-center user to access a web page;
accessing the requested webpage;
translating the accessed web page to a audio representation; and
playing the audio representation of the accessed web page to the call-center user.

18. The method of claim 17, further comprising:
reading the text portion of links contained in the webpage to the call-center user;
receiving a voice command from the call-center user to access an identified link;
accessing a web page associated with a target web address associated with the identified link requested by the call-center user.

19. A system for providing voice access to an electronic-mail system comprising:
a voice-recognition module configured to receive a voice command from a call-center user to compose an electronic-mail message;
a synthesizer configured to prompt the call-center user to begin dictating a body of the electronic-mail message;
a recording device configured to record the body of the electronic-mail message dictated by the call-center user;
a voice to text converter configured to translate the recorded body of the electronic-mail message into a text message; and
a mail-handler configured to send the electronic-mail message to an electronic-mail address containing the translated text message.

20. The system of claim 19, further comprising:
a text to voice converter configured to translate received text electronic-mail messages to audio representations of the text electronic-mail messages,
wherein the synthesizer is further configured to play received electronic-mail messages to the call-center user.

21. The system of claim 19, wherein the voice synthesizer is further configured to prompt the call-center user to recite electronic-mail destination information,
wherein the recording device is further configured to record the recited electronic-mail destination information;
wherein the voice to text converter is further configured to translate the recorded electronic-mail destination information into a text electronic-mail address,
wherein the mail-handler is configured to send the electronic-mail message to the text electronic-mail address.

22. A system for updating a web log utilizing an electronic-call-center comprising:
a voice-recognition module configured to receive a voice command from a call-center user to update a web log;
a synthesizer configured to prompt the call-center user to begin dictating a web log update message;
a recording device configured to record the web log update message dictated by the call-center user;
a voice to text converter configured to translate the web log update message into a text message; and
a publisher module configured to update the web log by appending the text message to the web log.

23. A method of editing a network profile utilizing an electronic call-center comprising:
receiving a voice command from a call-center user to edit a network profile;
prompting the call-center user to begin vocally recording a network profile update;
recording the vocal network profile update recited by the call-center user;
translating the recorded network profile update to a text message; and
storing the translated network profile text message and the recorded network profile update.

24. The method of claim 23 wherein the editing a network profile creates an initial profile for the call-center user.

25. A method of searching a plurality of network profiles comprising:
receiving a voice command from a call-center user search a plurality of network profiles;
prompting the call-center user to begin vocally recording a search string;
recording the vocal search string recited by the call-center user;
translating the recorded search string to a text message;
searching the plurality of network profiles based on the text search string; and
reciting a list of matching network profiles to the call-center user.

26. A method of sending a message to a network user comprising:
receiving a voice command from a call-center user to send a message to a network user;
prompting the call-center user to begin vocally recording the message to a network user;
recording the message to a network user recited by the call-center user;
translating the message to a network user to a text message; and
storing the text message and the recorded message to a network user.

27. A system for sending electronic-mail from within a motor vehicle comprising:
an embedded control having an activation button configured to connect to a call center;
a voice-recognition module configured to receive a voice command through the embedded control to compose an electronic-mail message;
a synthesizer configured to issue a prompt through the embedded control to begin dictating a body of the electronic-mail message;
a recording device configured to record the body of the electronic-mail message dictated through the embedded control;
a voice to text converter configured to translate the recorded body of the electronic-mail message into a text message; and
a mail-handler configured to send the electronic-mail message to an electronic-mail address containing the translated text message.

28. A system for interacting with web content by voice over a phone comprising:
a text to voice converter configured to translate a web page into an audio representation of the web page; and
a synthesizer configured to play the audio representation of the web page to a user;

29. The system of claim 28, further comprising:
a voice-recognition module configured to receive a link selection command from the user,
wherein the synthesizer is further configured to list for a set of links contained in the translated web page to the user for selection.
